(19) United States
(12) Patent Application Publication
(10) Pub. No.: US 2022/0309942 A1
(43) Pub. Date: Sep. 29, 2022

(54) INFORMATION PROVIDING METHOD

(71) Applicant: NEC Corporation, Minato-ku, Tokyo (JP)

(72) Inventor: Naomi KAWAMURA, Tokyo (JP)

(73) Assignee: NEC Corporation, Minato-ku, Tokyo (JP)

(21) Appl. No.: 17/637,175

(22) PCT Filed: Dec. 26, 2019
(86) PCT No.: PCT/JP2019/051143

§ 371 Date: Feb. 22, 2022

(51) Int. Cl. G09B 7/12; G09B 7/07

(52) U.S. Cl. CPC G09B 7/12; G09B 7/07

(57) ABSTRACT

An information providing system 100 of the present invention includes a question/answer unit 121 that, in response to a question sentence input by a user, outputs, to the user, candidate question sentences corresponding to the question sentence, a detection unit 122 that detects behavior of the user with respect to the candidate question sentences, and an evaluation unit 123 that evaluates the candidate question sentences with respect to the question sentence according to the behavior.

### TECHNICAL FIELD

The present invention relates to an information providing method, an information providing system, and a program, for providing information in response to a question from a user.

### BACKGROUND ART

As a system for automatically answering questions from users using a web server on the Internet or a computer installed in a store, a system called chatbot has been known. For example, in a chatbot, Q&A data configured of combinations of candidate question sentences and answer sentences is stored in advance. The chatbot analyzes a question sentence input from a user, extracts candidate question sentences corresponding to the question sentence, and presents one or a plurality of candidate question sentences to the user. Then, the chatbot allows the user to select a candidate question sentence that is closest to the content that the user wishes to ask from the candidate question sentences, and displays an answer sentence associated with the selected candidate question sentence. For example, Patent Literature 1 discloses an example of a chatbot.

In order to improve the accuracy of response to a question from a user, the chatbot employs a function of receiving feedback from a user indicating whether or not the finally presented answer is correct. For example, after displaying the answer, the chatbot requests a user to input evaluation of whether the answer is a “correct answer”, a “wrong answer”, or “unsolved”. Thereby, the chatbot analyzes and learns evaluation by the user with respect to the answer to thereby improve the accuracy of response to the subsequent questions from users.
Patent Literature 1: JP 2019-185614 A

### SUMMARY

However, when requesting a user to evaluate the answer by the chatbot as described above, there is a case where evaluation from a user cannot be obtained. This results in a problem that feedback from a user cannot be obtained so that the accuracy of response to the question cannot be improved.

In view of the above, an object of the present invention is to provide an information providing method that can solve the above-described problem, that is, a problem that the accuracy of response to questions cannot be improved in a chatbot.

An information providing method, according to one aspect of the present invention, is configured to include

in response to a question sentence input by a user, outputting to the user a candidate question sentence corresponding to the question sentence;

detecting behavior of the user with respect to the candidate question sentence; and

evaluating the candidate question sentence with respect to the question sentence according to the behavior.

Further, an information providing system, according to one aspect of the present invention, is configured to include

a question/answer unit that, in response to a question sentence input by a user, outputs to the user a candidate question sentence corresponding to the question sentence;

a detection unit that detects behavior of the user with respect to the candidate question sentence; and

an evaluation unit that evaluates the candidate question sentence with respect to the question sentence according to the behavior.

Further, a program, according to one aspect of the present invention, is configured to causing an information processing device to realize:

a question/answer unit that, in response to a question sentence input by a user, outputs a candidate question sentence corresponding to the question sentence to the user;

a detection unit that detects behavior of the user with respect to the candidate question sentence; and

an evaluation unit that evaluates the candidate question sentence with respect to the question sentence according to the behavior.

With the configurations described above, the present invention enables improvements in the accuracy of response to questions in the chatbot.

### BRIEF DESCRIPTION OF DRAWINGS

FIG. 1 is a block diagram illustrating a configuration of a chatbot according to the present invention.

FIG. 2 illustrates exemplary data stored in the chatbot disclosed in FIG. 1.

FIG. 3 illustrates exemplary data stored in the chatbot disclosed in FIG. 1.

FIG. 4A illustrates exemplary data stored in the chatbot disclosed in FIG. 1.

FIG. 4B illustrates exemplary data stored in the chatbot disclosed in FIG. 1.

FIG. 5A illustrates a state of question and answer operation between the chatbot disclosed in FIG. 1 and a user terminal.

FIG. 5B illustrates a state of question and answer operation between the chatbot disclosed in FIG. 1 and a user terminal.

FIG. 5C illustrates a state of question and answer operation between the chatbot disclosed in FIG. 1 and a user terminal.

FIG. 5D illustrates a state of question and answer operation between the chatbot disclosed in FIG. 1 and a user terminal.

FIG. 5E illustrates a state of question and answer operation between the chatbot disclosed in FIG. 1 and a user terminal.

FIG. 5F illustrates a state of question and answer operation between the chatbot disclosed in FIG. 1 and a user terminal.

FIG. 5G illustrates a state of question and answer operation between the chatbot disclosed in FIG. 1 and a user terminal.

FIG. 6 is a flowchart illustrating an operation of the chatbot disclosed in FIG. 1.

FIG. 7 is a block diagram illustrating a hardware configuration of an information providing system according to a second exemplary embodiment of the present invention.

FIG. 8 is a block diagram illustrating a configuration of the information providing system according to the second exemplary embodiment of the present invention.

FIG. 9 is a flowchart illustrating an operation of an information providing system according to a third exemplary embodiment of the present invention.

### EXEMPLARY EMBODIMENTS

### First Exemplary Embodiment

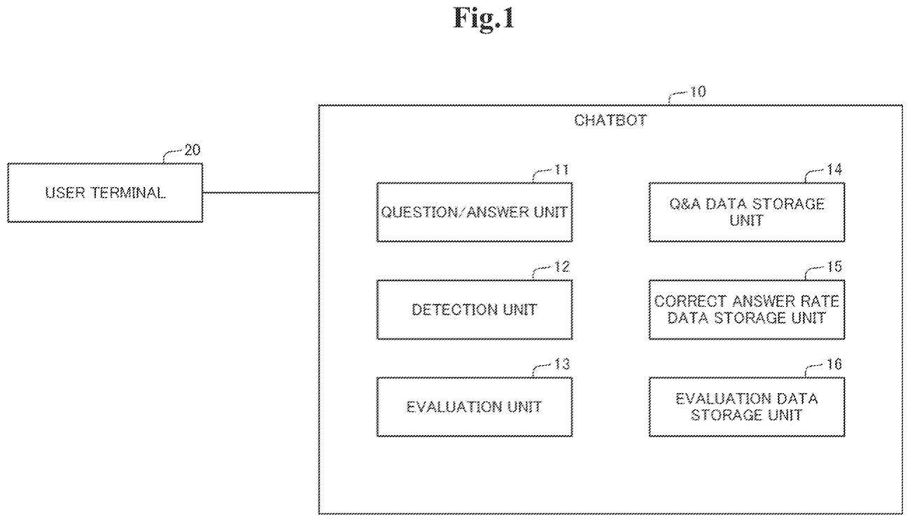

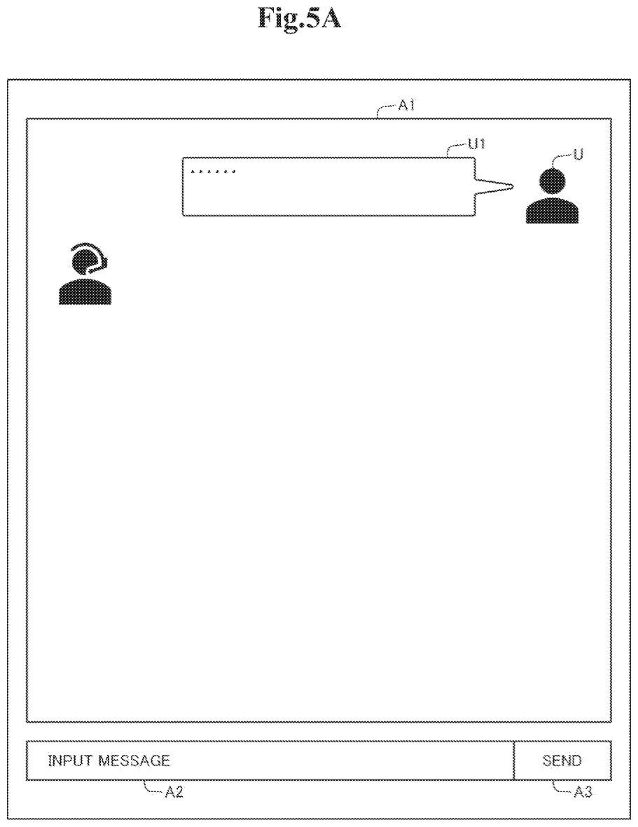

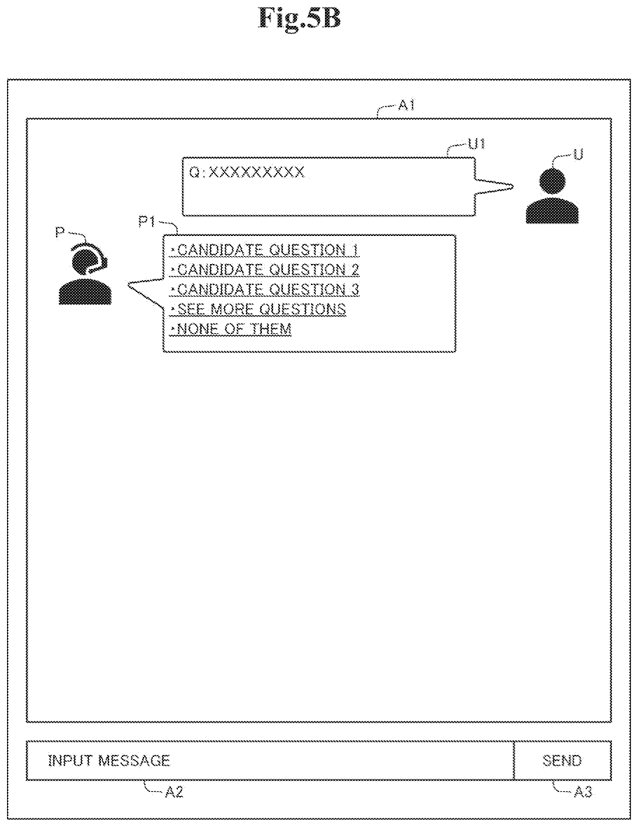

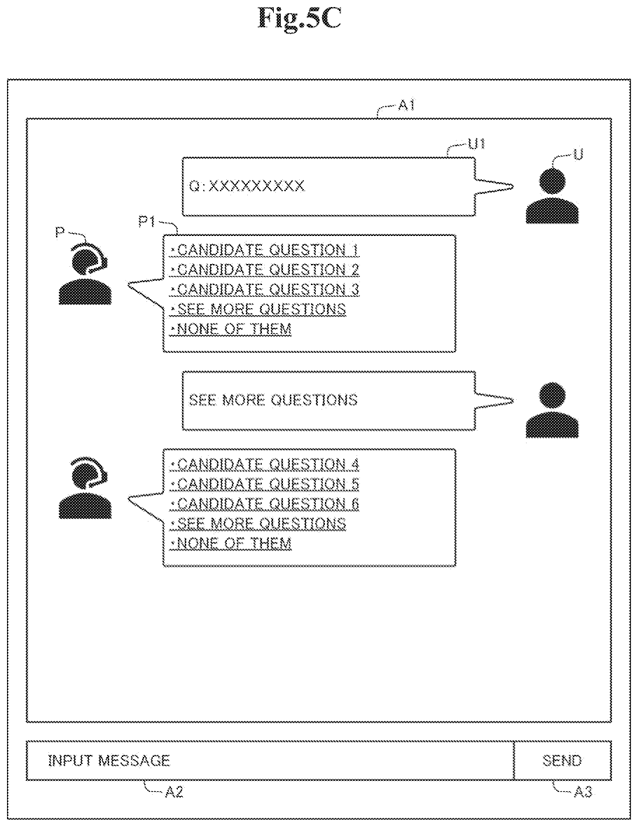

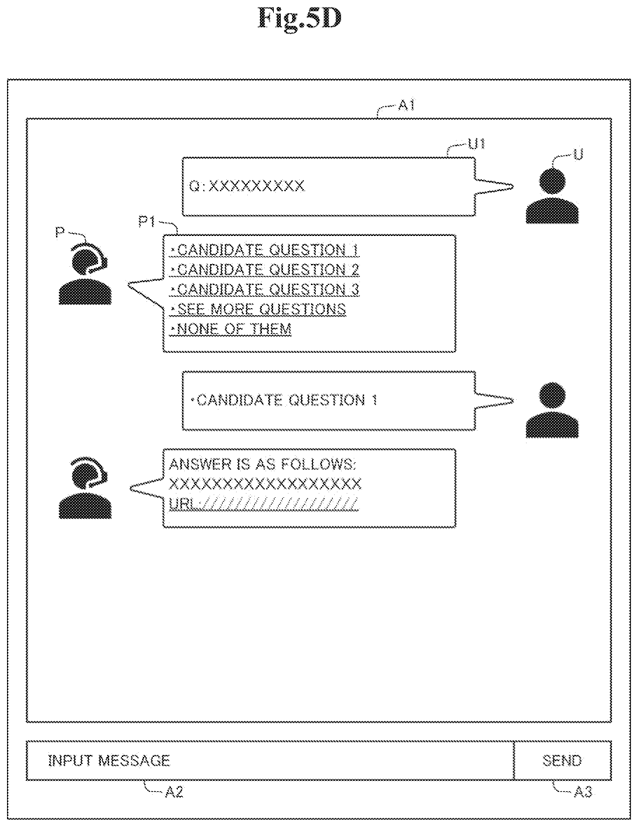

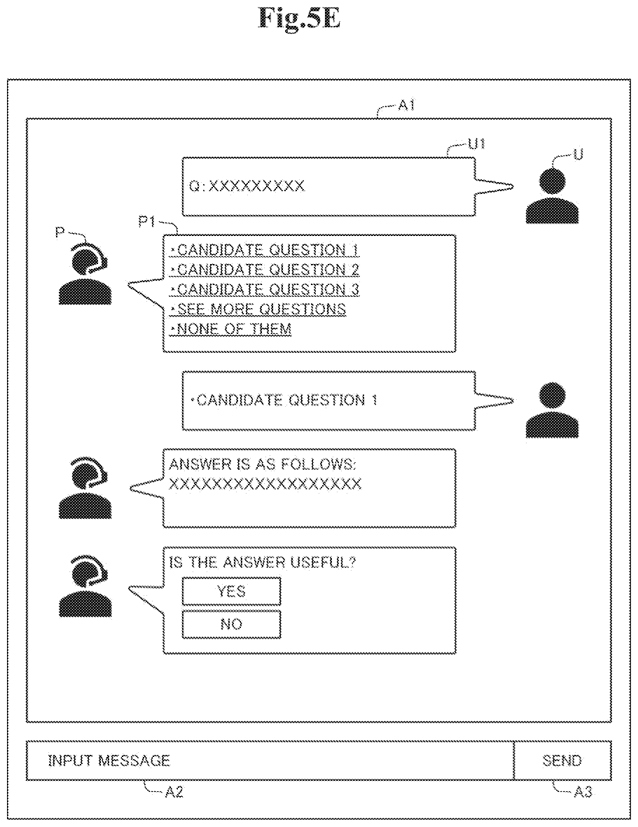

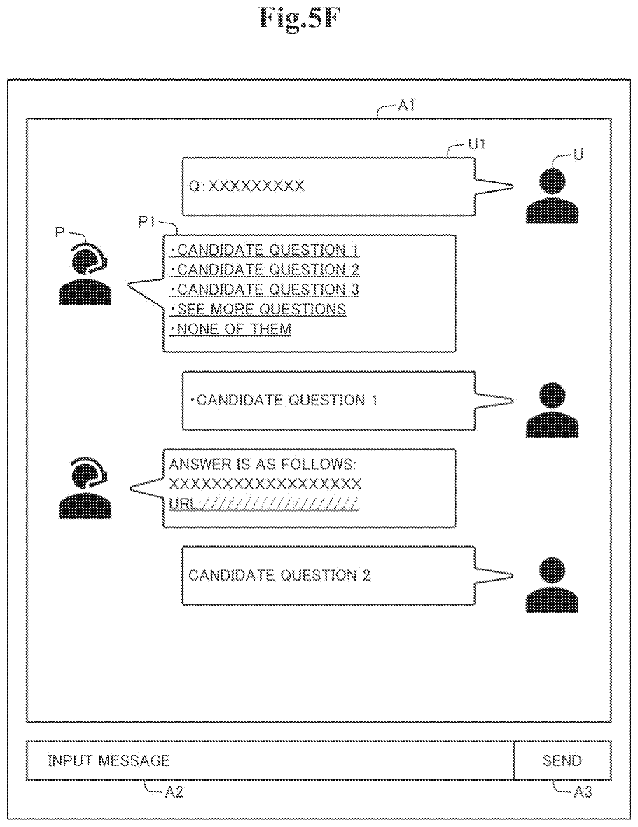

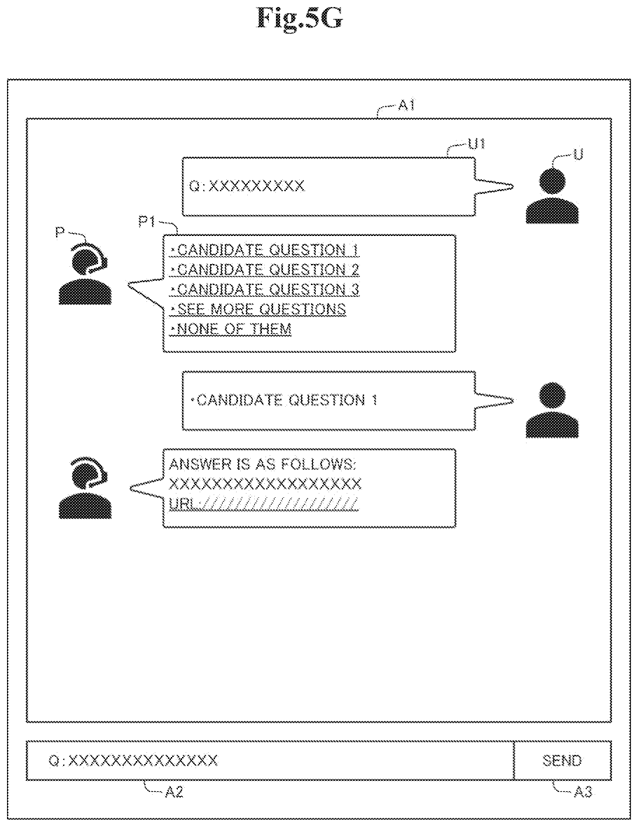

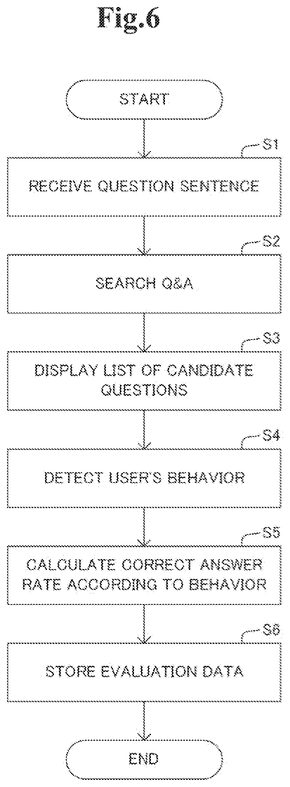

A first exemplary embodiment of the present invention will be described with reference to FIGS. 1 to 6. FIGS. 1 to 4 are diagrams for explaining a configuration of a chatbot, and FIGS. 5 to 6 are illustrations for explaining processing operation of the chatbot.

### [Configuration]

A chatbot 10 of the present invention is configured of a web server connected to a network, and functions as an information providing system that receives a question from a user terminal 20 (information processing device) operated by a user U and automatically provides an answer to the question. For example, the chatbot 10 may be managed by a company and provide answers to questions from the employees (users) in the company, or may be managed by a provider who provides products or services, and automatically provide answers to questions regarding the products or services from users who access thereto over a network.

However, the chatbot 10 of the present invention may be used in any scenes, and may provide any information. Moreover, the chatbot 10 is not limited to be configured of an information processing system that receives a question from the user terminal 20 and provides an answer over a network. For example, the chatbot 10 may be an information processing system configured of a terminal installed in a store or the like, and configured to directly receive a question from a user and provide an answer via text information or voice information.

The chatbot 10 of the present embodiment is configured of one or a plurality of information processing devices each having an arithmetic device and a storage device. As illustrated in FIG. 1, the chatbot 10 includes a question/answer unit 11, a detection unit 12, and an evaluation unit 13 that are constructed by execution of a program by the arithmetic device. The chatbot 10 also includes a Q&A data storage unit 14, a correct answer rate data storage unit 15, and an evaluation data storage unit 16 that are formed in the storage device. Hereinafter, each configuration will be described in detail.

The question/answer unit 11 first outputs, to the display screen of the user terminal 20 accessing thereto, a chat screen A1, a message input box A2, and a send button A3 to display them, as illustrated in FIG. 5A. The chat screen A1 is a screen on which messages exchanged between a user U and an operator P are shown. The message input box A2 is an input box into which the user U inputs a question sentence via the user terminal 20, and when the send button A3 is pressed, the question sentence is sent to the chatbot 10 and is received by the chatbot 10.

Then, when the question/answer unit 11 receives the question sentence from the user terminal 20, as illustrated in FIG. 5B, the question/answer unit 11 outputs and displays the question sentence from the user U in a question box U1 on the chat screen A1, and in response to it, outputs and displays candidate question sentences in a reply box P1 of an operator P on the chat screen A1. At that time, the question/answer unit 11 searches the Q&A data storage unit 14 for candidate question sentences corresponding to the question sentence from the user U and extracts them, and displays the extracted candidate question sentences in the reply box P1 on the chat screen A1.

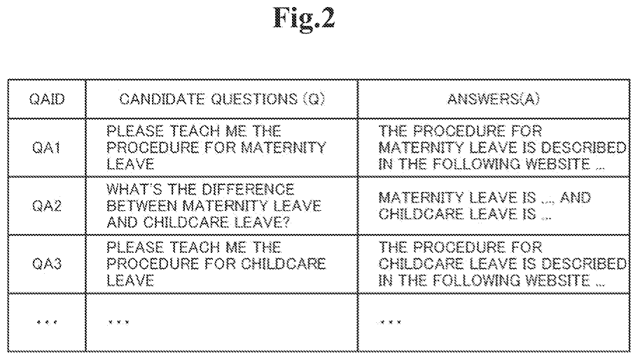

In the Q&A data storage unit 14, as illustrated in FIG. 2, Q&A data configured of combinations of candidate question sentences and answer sentences, prepared in advance, is stored. For example, as an example of Q&A data, in Q&A data of QAID “QA1”, a combination of a candidate question sentence “Please teach me the procedure for maternity leave”, and an answer sentence “The procedure for maternity leave is described in the following website . . . (URL)” is registered. Note that the Q&A data may be a combination of a candidate question sentence and an answer sentence of any contents.

Then, the question/answer unit 11 extracts candidate question sentences corresponding to the question sentence from the user U, from the candidate question sentences in the Q&A data storage unit 14. For example, the question/answer unit 11 stores a model in which candidate question sentences (Q&A data) corresponding to a question sentence are machine-learned, and when a question sentence from the user U is input to the model, one or a plurality of candidate question sentences are output, and the output candidate question sentences are extracted. Note that extraction of candidate question sentences corresponding to a question sentence by the question/answer unit 11 may be performed by another well-known method, or may be performed by any method.

The question/answer unit 11 displays a list of question and answer sentences extracted as described above in the reply box P1 from the operator P, as illustrated in FIG. 5B. In this example, since a plurality of candidate question sentences (1, 2, 3) are extracted, the question/answer unit 11 displays all of them in the reply box P1. Here, the question/answer unit 11 displays and outputs the respective candidate question sentences so as to be selectable by the user U. However, any number of candidate question sentences may be shown in the reply box P1 by the question/answer unit 11. When no candidate question sentence is extracted with respect to the question sentence, since the question/answer unit 11 can determine that the question sentence is inappropriate, the question/answer unit 11 may give an evaluation that the question sentence is inappropriate.

The question/answer unit 11 also displays in the reply box P1 an option indicating a request of the user U to output other candidate question sentences such as “see more questions”, along with the list of candidate question sentences (1, 2, 3) described above. Here, the question/answer unit 11 displays and outputs the option “see more questions” so as to be selectable by the user U. Note that the wording “see more questions” may be a different one. The content thereof may be one that the user U wishes to output still other candidate question sentences in addition to the candidate question sentences shown.

The question/answer unit 11 also displays an option “none of them” in addition to the options of the candidate question sentences (1, 2, 3) and the option “see more questions”, in the reply box P1. Note that the option “none of them” is an option for indicating there is no candidate question sentence intended by the user U in the displayed candidate question sentences, and the wording may be a different one. Then, the question/answer unit 11 displays and outputs the option “none of them” so as to be selectable by the user U.

Note that the question/answer unit 11 also provides various types of information to the user U by displaying them on the chat screen A1, according to the behavior of the user U detected by the detection unit 12 as displayed below. The details thereof will be described later.

The detection unit 12 detects behavior of the user U after the candidate question sentences and the like are shown in the reply box P1 on the chat screen A1, as described in FIGS. 5A to 5G. For example, as behavior of the user U, the detection unit 12 detects a state of selection by the user U from the respective options including the candidate question sentences shown in the reply box P1. As an example, the detection unit 12 detects one selected on the chat screen A1 displayed on the display screen of the user terminal 20 by operation of the user terminal 20 by the user U, among the candidate question sentences (1, 2, 3), “see more questions”, and “none of them” shown in the reply box P1.

As the behavior of the user U, the detection unit 12 also detects that, after displaying the candidate question sentences and the like in the reply box P1, another question sentence is input into the message input box A2 and the send button A3 is pressed by the user U. The other question sentence input at the time is received by the question/answer unit 11, and candidate question sentences and the like corresponding to the other question sentence are output to the user terminal 20, as similar to the above-described case. Further, as behavior of the user U, the detection unit 12 detects an operation of ending question such as not selecting any candidate question sentence in the reply box P1 and not inputting another question sentence as described above, and closing the chat screen A1.

As a result of selecting any of the candidate question sentences by the user U as described below, when an answer sentence corresponding to the candidate question sentence is output by the question/answer unit 11, the detection unit 12 also detects behavior (second behavior) of the user U with respect to the answer sentence. For example, as behavior of the user U, when a link (address information) to another web page containing more detailed answer is included in the answer sentence, the detection unit 12 detects whether or not the link is selected by the user U. Further, when evaluation of the answer is input by the user U following the answer sentence, the detection unit 12 detects the degree of evaluation. For example, when a button indicating that the answer is useful for the user and a button indicating that it is not useful are shown, the detection unit 12 detects which button is selected.

Here, the question/answer unit 11 will be described again. After displaying candidate question sentences corresponding to the question from the user U as described above, the question/answer unit 11 takes various actions such as providing further information to the user U according to the behavior of the user detected by the detection unit 12. In the below description, behavior of the user U will be described with a “pattern number”.

First, when the user U does not select any of the candidate question sentences and the like shown in the reply box P1 illustrated in FIG. 5B and ends the question by closing the chat screen A1 or the like (Pattern 1), the question/answer unit 11 ends the answer processing without continuing answering to the question.

Meanwhile, when the user selects “see more questions” with respect to the candidate question sentences and the like shown in the reply box P1 illustrated in FIG. 5B (Pattern 2), the question/answer unit 11 further extracts other candidate question sentences corresponding to the first question sentence from the Q&A data storage unit 14 as described above. Then, as illustrated in FIG. 5C, the question/answer unit 11 displays “see more questions” in the question box U1 of the user on the chat screen A1, and also displays other extracted candidate question sentences (4, 5, 6) and other options in the reply box P1 of the operator P. When the user selects “none of them” with respect to the candidate question sentences and the like shown in the reply box P1 illustrated in FIG. 5B (Pattern 6), the question/answer unit 11 may further extract other candidate question sentences corresponding to the first question sentence as described above, or end the answering processing without continuing answering to the question.

When the user selects one candidate question sentence (for example, candidate question 1) from the candidate question sentences and the like shown in the reply box P1 illustrated in FIG. 5B, the question/answer unit 11 specifies Q&A data including the selected candidate question sentence from the Q&A data storage unit 14, and reads out the answer sentence associated with the selected candidate question sentence in the specified Q&A data. Then, as illustrated in FIG. 5D, the question/answer unit 11 displays “candidate question 1” in the question box U1 of the user U on the chat screen A1, and also displays “answer sentence” corresponding to the selected candidate question sentence in the reply box P1 of the operator P. Then, when the user U ends the question by closing the chat screen A1 or the like (Pattern 3), the question/answer unit 11 determines that answering to the question is completed, and ends the answering processing.

At that time, when a link (address information (for example, URL)) to another web page describing a more detailed answer is included in the answer sentence, the question/answer unit 11 also displays the link to such a web page in the reply box P1 on the chat screen A1 as illustrated in FIG. 5D. Then, when the link included in the answer sentence is selected by the user U, the question/answer unit 11 provides the linked web page by displaying it on the user terminal 20 (Pattern 8). Further, as illustrated in FIG. 5E, the question/answer unit 11 displays an input means to which the degree of evaluation by the user with respect to the answer is input following the answer sentence. As such an input means, for example, a button indicating that the answer is useful for the user and a button indicating that it is not useful are displayed. Then, when either one of the buttons is selected by the user U (Pattern 9), the question/answer unit 11 ends answering to the question from the user. As an input means for inputting the degree of evaluation by the user with respect to the answer, the question/answer unit 11 may display an input means with which evaluation can be input in three or more stages, without being limited to the two buttons described above.

Further, as illustrated in FIG. 5D, although an answer sentence corresponding to the candidate question sentence has been already shown, when the user U selects another candidate question sentence (for example, candidate question 2) from the candidate question sentences and the like shown in the reply box P1 (Pattern 4), the question/answer unit 11 displays the other selected candidate sentence in the question box U1 of the user U as illustrated in FIG. 5F. Then, the question/answer unit 11 displays the answer sentence to the other candidate question sentence in the reply box P1 as similar to the above-described case, although not illustrated.

Further, as illustrated in FIG. 5G, although the answer sentence corresponding to the candidate question sentence is already shown, when a new question sentence is input into the message input box A2 by the user U and the send button A3 is pressed (Pattern 5), the question/answer unit 11 receives the new question sentence, and displays it in the question box U1 of the user U on the chat screen A1 as similar to the above-described case. As illustrated in FIG. 5B, even when the user U does not select any of the candidate question sentences shown in the reply box P1 and the user U inputs a new question sentence in the message input box A2 (Pattern 7), the question/answer unit 11 receives the new question sentence as similar to the above-described case, and displays it in the question box U1 of the user U on the chat screen A1 as similar to the above-described case. Then, the question/answer unit 11 extracts new candidate question sentences corresponding to the new question sentence and displays them in the reply box P1, as similar to the above-described case.

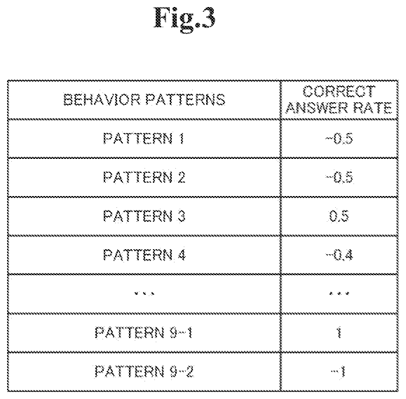

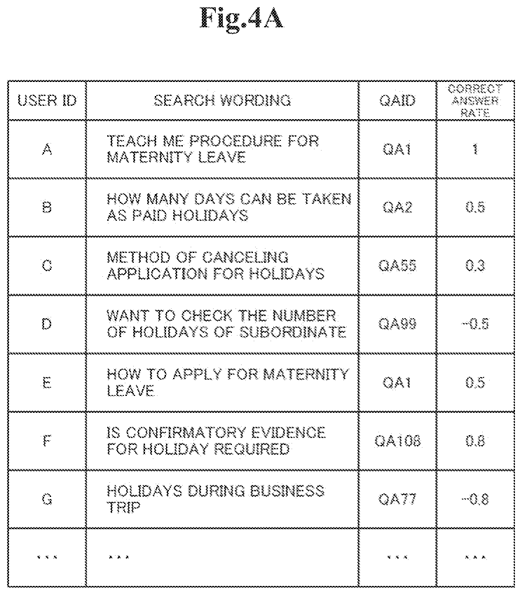

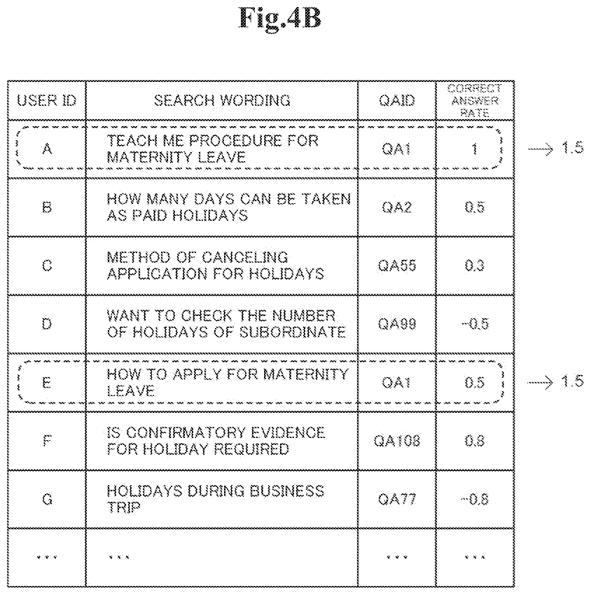

The evaluation unit 13 evaluates the candidate question sentence with respect to the question sentence according to the behavior of the user U detected by the detection unit 12 as described above. In the present embodiment, the correct answer rate is set for each pattern number corresponding to the behavior of the user U as described above, and the evaluation unit 13 associates the correct answer rate with evaluation data in which the actually input question sentence and the candidate question sentence extracted corresponding to the question sentence are included as a pair. Then, as illustrated in FIG. 4A, the evaluation unit 13 stores, in the evaluation data storage unit 16, the user ID of the user U who input the question, the input question sentence, the QAID of the Q&A data including the extracted candidate question sentence, and the correct answer rate, in association with one another as evaluation data. Note that the correct answer rate is a value representing the degree that the candidate question sentence output corresponding to the question sentence input by the user U is correct. As illustrated in the correct answer rate table of FIG. 3, it is set for each pattern number corresponding to the behavior of the user U in advance.

Specifically, the evaluation unit 13 calculates the correct answer rate of the candidate question sentence extracted corresponding to the question sentence, according to the behavior of the user U detected by the detection unit 12 as described below. First, consideration will be given on the case of Pattern 1, that is, the case where the user U selects nothing from the displayed candidate question sentences and the like and ends the question by closing the chat screen A1 or the like. In that case, since it can be determined that it is highly possible that all of the candidate question sentences extracted corresponding to the question sentence are “wrong answers”, the correct answer rate is set to “−0.5”. This value is calculated as the correct answer rate of all of the candidate question sentences with respect to the question sentence. In the case of Pattern 2 in which the user U selects “see more questions” and the case of Pattern 6 in which the user selects “none of them” with respect to the displayed candidate question sentences and the like, since it can also be determined that it is highly possible that all of the candidate question sentences extracted with respect to the question sentence are “wrong answers”, the correct answer rate is set to “−0.5”, and the value is calculated as the correct answer rate.

Next, consideration will be given on the case of Pattern 3, that is, the user U selects one candidate question sentence (for example, candidate question 1) from the displayed candidate question sentences and the like, and an answer sentence corresponding to the candidate question sentence is shown, and then the user U ends the question by closing the chat screen A1 or the like. In that case, since it can be determined that it is highly possible that the selected candidate question sentence corresponding to the question sentence is a “correct answer”, the correct answer rate is set to “0.5”. This value is calculated as the correct answer rate of the candidate question sentence selected with respect to the question sentence.

Next, consideration will be given on the case of Pattern 4, that is, the user U selects one candidate question sentence (for example, candidate question sentence 1) from the displayed candidate question sentences and the like, and although an answer sentence corresponding to the candidate question sentence is shown, the user U then selects another candidate question sentence (for example, candidate question 2). In that case, it can be determined that it is highly possible that the candidate question sentence selected first by the user U (for example, candidate question sentence 1) is a “wrong answer”. However, since it was selected once, the correct answer rate is set to “−0.4”. This value is calculated as the correct answer rate of the candidate question sentence selected first with respect to the question sentence.

Next, consideration will be given on the case of Pattern 5, that is, candidate question sentences and the like are displayed corresponding to the first question sentence from the user U, and the user U selects one candidate question sentence from the displayed candidate question sentences and the like, and although an answer sentence corresponding to the selected candidate question sentence is shown, the user U then inputs a new question sentence. In that case, the evaluation unit 13 analyzes the similarity relation between the first question sentence and the new question sentence. For example, the evaluation unit 13 determines whether or not the first question sentence and the new question sentence are similar to each other, by means of a known method. As an example, the evaluation unit 13 applies morpheme analysis to each of the first question sentence and the new question sentence and vector-digitizes it, calculates the similarity between them, and when the similarity is a predetermined value or larger, the evaluation unit 13 determines that they are similar. However, analysis of the similarity relation between the first question sentence and the new question sentence may be performed by means of any method. Then, when the evaluation unit 13 determines that the first question sentence and the new question sentence are similar to each other, since it can be determined that it is highly possible that the candidate question sentence selected with respect to the first question sentence is a “wrong answer”, the correct answer rate is set to a negative value. Therefore, the evaluation unit 13 calculates such a value as the correct answer rate of the candidate question sentence selected with respect to the first question sentence. On the other hand, when the evaluation unit 13 determines that the first question sentence and the new question sentence are not similar to each other, since it can be determined that it is highly possible that the candidate question sentence selected with respect to the first question sentence is a “correct answer”, the correct answer rate is set to a positive value. Therefore, the evaluation unit 13 calculates such a value as the correct answer rate of the candidate question sentence selected with respect to the first question sentence.

Next, consideration will be given on the case of Pattern 7, that is, although candidate question sentences and the like are displayed corresponding to the first question sentence from the user U, the user U does not select any of the displayed candidate question sentences and the like, and the user U inputs a new question sentence. In that case, the evaluation unit 13 analyzes the similarity relation between the first question sentence and the new question sentence, as similar to the above-described case. Then, when the evaluation unit 13 determines that the first question sentence and the new question sentence are similar to each other, since it can be determined that it is highly possible that all of the candidate question sentences displayed with respect to the first question sentence are “wrong answers”, the correct answer rate is set to a negative value. Therefore, the evaluation unit 13 calculates such a value as the correct answer rate of the candidate question sentences displayed with respect to the first question sentence. On the other hand, when the evaluation unit 13 determines that the first question sentence and the new question sentence are not similar to each other, since it cannot be determined that all of the candidate question sentences displayed with respect to the first question sentence are “correct answers” or “wrong answers”, the correct answer rate is set to 0. Therefore, the evaluation unit 13 calculates such a value as the correct answer rate of the candidate question sentences displayed with respect to the first question sentence.

Next, consideration will be given on the case of Pattern 8, that is, candidate question sentences and the like are displayed corresponding to the first question sentence from the user U, the user U selects one candidate question sentence from the displayed candidate question sentences and the like, an answer sentence corresponding to the selected candidate question sentence is shown, and the answer sentence includes a link to another web page describing the details of the answer. In that case, when the link is selected by the user U, since the evaluation unit 13 can determine that it is highly possible that the selected candidate question sentence corresponding to the question sentence is a “correct answer”, the correct answer rate is set to “1”. This value is calculated as the correct answer rate of the candidate question sentence selected with respect to the question sentence. On the other hand, when the link is not selected by the user U, since the evaluation unit 13 can determine that it is highly possible that the selected candidate question sentence corresponding to the question sentence is a “wrong answer”, the correct answer rate is set to “−0.5”. This value is calculated as the correct answer rate of the candidate question sentence selected with respect to the question sentence.

Next, consideration will be given on the case of Pattern 9, that is, candidate question sentences and the like are displayed corresponding to the first question sentence from the user U, the user U selects one candidate question sentence from the displayed candidate question sentences and the like, an answer sentence corresponding to the selected candidate question sentence is shown, and selection buttons representing the degree of evaluation by the user U with respect to the answer (buttons for selecting “whether or not the answer is useful”) are displayed. In that case, when a button representing “the answer is useful” is selected by the user U, since the evaluation unit 13 can determine that it is highly possible that the selected candidate question sentence corresponding to the question sentence is a “correct answer”, the correct answer rate is set to “1”. The evaluation unit 13 calculates this value as the correct answer rate of the candidate question sentence selected with respect to the question sentence. On the other hand, when a button representing “the answer is not useful” is selected by the user U, since the evaluation unit 13 can determine that it is highly possible that the selected candidate question sentence corresponding to the question sentence is a “wrong answer, the correct answer rate is set to “−1”. The evaluation unit 13 calculates this value as the correct answer rate of the candidate question sentence selected with respect to the question sentence.

The evaluation unit 13 also has a function of revising the correct answer rate associated with a candidate question sentence corresponding to a question sentence. At that time, the evaluation unit 13 calculates the similarity representing the degree that two pieces of evaluation data are similar to each other, and revises the correct answer rate included in each of the pieces of evaluation data according to the similarity. Specifically, the evaluation unit 13 first calculates the similarity between two pieces of evaluation data on the basis of a question sentence and candidate question sentences included in each piece of evaluation data. For example, regarding candidate question sentences, the evaluation unit 13 determines the similarity according to whether or not the QAID of the Q&A data including the candidate question sentence is the same, and regarding the question sentences, the evaluation unit 13 calculates the similarity between the question sentences by performing morpheme analysis. Then, the evaluation unit 13 comprehensively determines the similarity between the candidate question sentences and the similarity between the question sentences, and when determining that the two pieces of evaluation data are similar to each other, the evaluation unit 13 revises the correct answer rate by adding the other correct answer rate to the own correct answer rate. For example, as illustrated in FIG. 4B, when the evaluation unit 13 determines that the pieces of evaluation data in which the user ID corresponds to the question sentences of A and E are similar to each other, the evaluation unit 13 revises the correct answer rate by adding the correct answer rate to each other.

Note that calculation of the correct answer rate by the evaluation unit 13 described above is an example. It is also possible to calculate the correct answer rate according to the behavior of the user U by using other references or methods, and set the correct answer rate of each candidate question sentence with respect to a question sentence.

Then, the evaluation data described above is stored in the evaluation data storage unit 16, and then, it is used as learning data for machine learning for generating a model to be used for extracting candidate question sentences based on a question sentence. The correct answer rate included in the evaluation data is used as a weight for learning the model. Note that the evaluation data described above is not limited to be used as learning data for machine learning, and may be used in any scene.

[Operation]

Next, operation of the chatbot 10 described above will be described with mainly reference to the display screen of the user terminal 20 illustrated in FIGS. 5A to 5G and the flowchart of FIG. 6. When the chatbot 10 is accessed from the user terminal 20, the chatbot 10 displays the chat screen A1 as illustrated in FIG. 5A on the user terminal 20, and receives a question sentence input in the message input box A2 (step S1 of FIG. 6).

Then, the chatbot 10 searches the Q&A data storage unit 14 for candidate question sentences corresponding to the question sentence from the user U and extracts them (step S2 of FIG. 6), displays the question sentence from the user U in the question box U1 as shown in the chat screen A1 of FIG. 5B, and also displays a list of extracted candidate question sentences in the reply box P1 on the chat screen A1 (step S3 of FIG. 6). At that time, as illustrated in FIG. 5B, the chatbot 10 displays options such as “see more questions” and “none of them” in the reply box P1, along with the list of candidate question sentences (candidate question sentences 1, 2, 3).

Then, the chatbot 10 detects the behavior of the user U after the candidate question sentences and the like are shown in the reply box P1 on the chat screen A1 (step S4 of FIG. 6). For example, as the behavior of the user U, the chatbot 10 detects a state of selection by the user U with respect to the candidate question sentences and the options shown in the reply box P1, operation by the user U after the answer sentence is shown thereafter, and further input of another question sentence into the message input box AS2 by the user U.

Then, as illustrated in FIGS. 5C to 5G, in response to the behavior of the user U, the chatbot 10 outputs various displays in the question box U1 and the reply box P1 on the chat screen A1 and calculates the correct answer rate of each candidate question sentence with respect to the question sentence (step S5 of FIG. 6). At that time, the chatbot 10 refers to the preset correct answer rate table illustrated in FIG. 3 to determine the correct answer rate of each candidate question sentence with respect to the question sentence according to the behavior of the user U, and as illustrated in FIG. 4A, associates the correct answer rate with the question sentence and the candidate question sentence and stores them as evaluation data (step S6 of FIG. 6).

Note that the chatbot 10 revises the correct answer rate included in the evaluation data later at any timing. For example, the chatbot 10 calculates the similarity between the pieces of evaluation data, that is, the similarity between the question sentences and the similarity between the candidate question sentences included in the respective pieces of evaluation data, and when determining that the pieces of evaluation data are similar to each other, the chatbot 10 performs revision by adding the other correct answer rate to the own correct answer rate.

Then, the chatbot 10 can use the evaluation data later as learning data for generating a model to be used for extracting candidate question sentences based on a question sentence. At that time, the chatbot 10 uses the correct answer rate included in the evaluation data as a weight for learning the model.

As described above, according to the present invention, the chatbot 10 outputs, to the user, candidate question sentences corresponding to a question sentence input by the user, and corresponding to the behavior of the user with respect to the candidate question sentences, evaluates the candidate question sentences with respect to the question sentence. Therefore, the chatbot 10 can detect the behavior of the user in the process from the time when the user gives a question until the time when the user obtains the answer, and obtain evaluation of the candidate question sentence corresponding to the question sentence according to the behavior. As a result, the chatbot 10 can acquire evaluation of the response made to the question from the user U, whereby the accuracy of the response to the question can be improved.

Note that while the chatbot 10 in the embodiment described above is described to have a configuration of communicating with the user U by using text, the chatbot of the present invention may communicate with a user by using voices. That is, the chatbot may receive a question sentence from a user, output candidate question sentences to the user, and detect the behavior of the user, via voices.

### Second Exemplary Embodiment

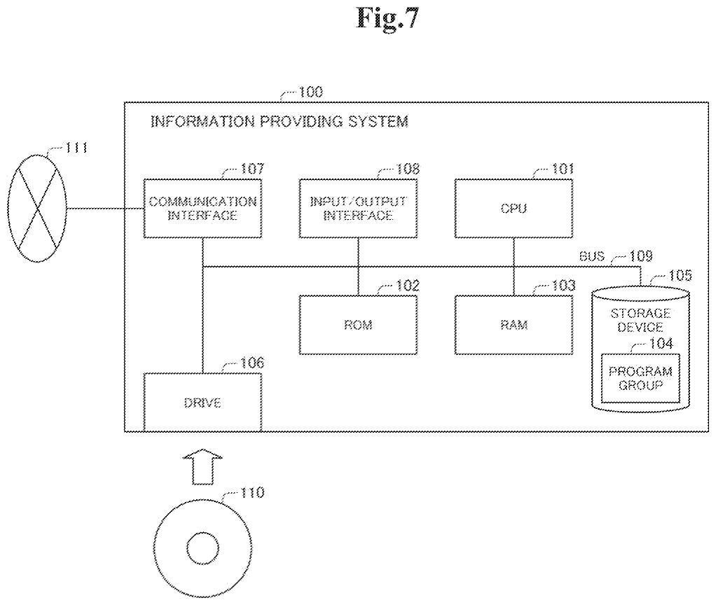

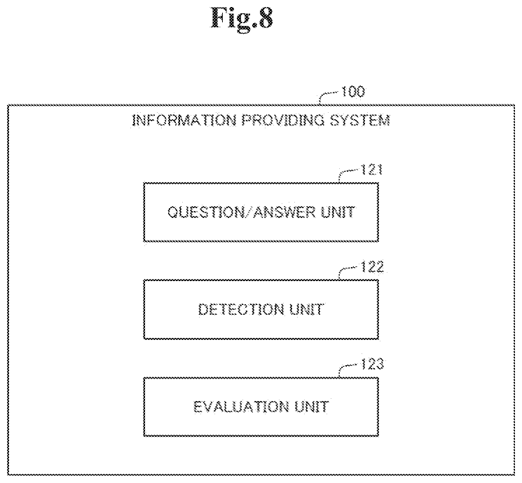

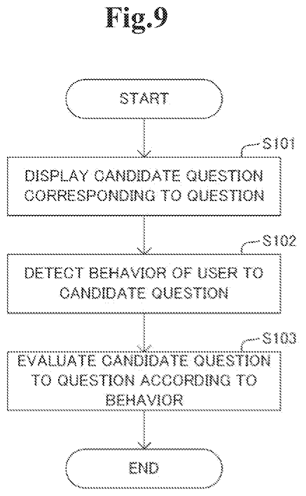

Next, a second exemplary embodiment of the present invention will be described with reference to FIGS. 7 to 9. FIGS. 7 and 8 are block diagrams illustrating the configuration of an information providing system according to the second exemplary embodiment, and FIG. 9 is a flowchart illustrating the operation of the information providing system. Note that the present embodiment shows the outlines of the configurations of the chatbot and the information providing method described in the first exemplary embodiment.

First, a hardware configuration of an information providing system 100 in the present embodiment will be described with reference to FIG. 7. The information providing system 100 is configured of a typical information processing device, having a hardware configuration as described below as an example.

Central Processing Unit (CPU) 101 (arithmetic device)

Read Only Memory (ROM) 102 (storage device)

Random Access Memory (RAM) 103 (memory device)

Program group 104 to be loaded to the RAM 303

Storage device 105 storing therein the program group 104

Drive 106 that performs reading and writing on storage medium 110 outside the information processing device

Communication interface 107 connecting to a communication network 111 outside the information processing device

Input/output interface 108 for performing input/output of data

Bus 109 connecting the respective constituent elements

The information providing system 100 can construct, and can be equipped with, a question/answer unit 121, a detection unit 122, and an evaluation unit 123 illustrated in FIG. 8, through acquisition and execution of the program group 104 by the CPU 101. Note that the program group 104 is stored in the storage device 105 or the ROM 102 in advance, and is loaded to the RAM 103 by the CPU 101 as needed. Further, the program group 104 may be provided to the CPU 101 via the communication network 111, or may be stored on the storage medium 110 in advance and read out by the drive 106 and supplied to the CPU 101. However, the question/answer unit 121, the detection unit 122, and the evaluation unit 123 may be constructed by electronic circuits.

Note that FIG. 7 illustrates an example of the hardware configuration of the information processing device constituting the information providing system 100. The hardware configuration thereof is not limited to that described above. For example, the information processing device may be configured of part of the configuration described above, such as without the drive 106.

The information providing system 100 executes the information providing method illustrated in the flowchart of FIG. 9, by the functions of the question/answer unit 121, the detection unit 122, and the evaluation unit 123 constructed by the program as described above.

As illustrated in FIG. 9, the information providing system 100

outputs, in response to a question sentence input by a user, a candidate question sentence corresponding to the question sentence, to the user (step S101),

detects behavior of the user with respect to the candidate question sentence (step S102), and

evaluates the candidate question sentence with respect to the question sentence according to the behavior (step S103).

Since the present embodiment is configured as described above, the information providing system 100 outputs, to the user, candidate question sentences corresponding to a question sentence input by the user, and evaluates the candidate question sentences with respect to the question sentence according to the behavior of the user with respect to the candidate question sentences. Therefore, the information providing system 100 can detect the behavior of the user in the process from the time when the user gives a question until the time when the user obtains the answer, and obtain evaluation of the candidate question sentences corresponding to the question sentence according to the behavior. As a result, the information providing system 100 can acquire evaluation of the response made to the question from the user U, and improve the accuracy of the response to the question.

### <Supplementary Notes>

The whole or part of the exemplary embodiments disclosed above can be described as the following supplementary notes. Hereinafter, outlines of the configurations of an information providing method, an information providing system, and a program, according to the present invention, will be described. However, the present invention is not limited to the configurations described below.

### (Supplementary Note 1)

An information providing method comprising:

in response to a question sentence input by a user, outputting to the user a candidate question sentence corresponding to the question sentence;

detecting behavior of the user with respect to the candidate question sentence; and

evaluating the candidate question sentence with respect to the question sentence according to the behavior.

### (Supplementary Note 2)

The information providing method according to supplementary note 1, further comprising:

by a question and answer unit, outputting the candidate question sentence onto a display screen of an information processing device operated by the user;

by a detection unit, as the behavior, detecting an operation by the user performed on the display screen on which the candidate question sentence is shown; and

by an evaluation unit, evaluating the candidate question sentence with respect to the question sentence according to the operation.

### (Supplementary Note 3)

The information providing method according to supplementary note 1 or 2, further comprising:

by a detection unit, as the behavior, detecting a state of selection by the user with respect to the candidate question sentence output to the user; and

by an evaluation unit, evaluating the candidate question sentence with respect to the question sentence according to the state of selection by the user with respect to the candidate question sentence.

### (Supplementary Note 4)

The information providing method according to supplementary note 3, further comprising:

by a question and answer unit, outputting the candidate question sentence to the user, and outputting to the user an option for requesting output of another candidate question sentence;

by the detection unit, as the behavior, detecting the state of selection by the user with respect to the candidate question sentence and the option; and

by the evaluation unit, evaluating the candidate question sentence with respect to the question sentence according to the state of selection by the user with respect to the candidate question sentence and the option.

### (Supplementary Note 5)

The information providing method according to supplementary note 1 or 4, further comprising:

by a detection unit, after the candidate question sentence is output to the user, detecting further input of another question sentence from the user; and

by an evaluation unit, evaluating the candidate question sentence with respect to the question sentence on a basis of the question sentence and the other question sentence.

### (Supplementary Note 6)

The information providing method according to supplementary note 5, further comprising

by the evaluation unit, analyzing a similarity relation between the question sentence and the other question sentence, and evaluating the candidate question sentence with respect to the question sentence on a basis of an analysis result.

### (Supplementary Note 7)

The information providing method according to any of supplementary notes 1 to 6, further comprising:

by a question and answer unit, according to the behavior of the user with respect to the candidate question sentence, outputting an answer sentence corresponding to the candidate question sentence to the user;

by a detection unit, detecting second behavior of the user with respect to the answer sentence; and

by an evaluation unit, evaluating the candidate question sentence with respect to the question sentence according to the second behavior.

### (Supplementary Note 8)

The information providing method according to any of supplementary notes 1 to 7, further comprising:

by an evaluation unit, as evaluation of the candidate question sentence with respect to the question sentence, calculating a correct answer rate that represents a degree that the candidate question sentence output corresponding to the question sentence is correct according to the behavior, and storing the correct answer rate in association with data in which the question sentence and the candidate question sentence are paired.

### (Supplementary Note 9)

The information providing method according to supplementary note 8, further comprising:

by the evaluation unit, calculating similarity that represents a degree that pieces of data in each of which the question sentence and the candidate question sentence are paired are similar to each other, and revising the correct answer rate associated with each of the pieces of data according to the similarity.

### (Supplementary Note 10)

An information providing system comprising:

a question and answer unit that, in response to a question sentence input by a user, outputs to the user a candidate question sentence corresponding to the question sentence;

a detection unit that detects behavior of the user with respect to the candidate question sentence; and

an evaluation unit that evaluates the candidate question sentence with respect to the question sentence according to the behavior.

### (Supplementary Note 11)

The information providing system according to supplementary note 10, wherein

the question and answer unit outputs the candidate question sentence onto a display screen of an information processing device operated by the user,

as the behavior, the detection unit detects an operation by the user performed on the display screen on which the candidate question sentence is shown, and

the evaluation unit evaluates the candidate question sentence with respect to the question sentence according to the operation.

### (Supplementary Note 12)

The information providing system according to supplementary note 10 or 11, wherein

as the behavior, the detection unit detects a state of selection by the user with respect to the candidate question sentence output to the user, and

the evaluation unit evaluates the candidate question sentence with respect to the question sentence according to the state of selection by the user with respect to the candidate question sentence.

### (Supplementary Note 13)

The information providing system according to supplementary note 12, wherein

the question and answer unit outputs the candidate question sentence to the user, and outputs to the user an option for requesting output of another candidate question sentence,

as the behavior, the detection unit detects the state of selection by the user with respect to the candidate question sentence and the option, and

the evaluation unit evaluates the candidate question sentence with respect to the question sentence according to the state of selection by the user with respect to the candidate question sentence and the option.

### (Supplementary Note 14)

The information providing system according to supplementary note 10 or 13, wherein

after the candidate question sentence is output to the user, the detection unit detects further input of another question sentence from the user, and

the evaluation unit evaluates the candidate question sentence with respect to the question sentence on a basis of the question sentence and the other question sentence.

### (Supplementary Note 15)

The information providing system according to supplementary note 14, wherein

the evaluation unit analyzes a similarity relation between the question sentence and the other question sentence, and evaluates the candidate question sentence with respect to the question sentence on a basis of an analysis result.

### (Supplementary Note 16)

The information providing system according to any of supplementary notes 10 to 15, wherein

according to the behavior of the user with respect to the candidate question sentence, the question and answer unit outputs to the user an answer sentence corresponding to the candidate question sentence,

the detection unit detects second behavior of the user with respect to the answer sentence, and

the evaluation unit evaluates the candidate question sentence with respect to the question sentence according to the second behavior.

### (Supplementary Note 17)

The information providing system according to any of supplementary notes 10 to 16, wherein

as evaluation of the candidate question sentence with respect to the question sentence, the evaluation unit calculates a correct answer rate that represents a degree that the candidate question sentence output corresponding to the question sentence is correct according to the behavior, and stores the correct answer rate in association with data in which the question sentence and the candidate question sentence are paired.

### (Supplementary Note 18)

The information providing system according to supplementary note 17, wherein

the evaluation unit calculates similarity that represents a degree that pieces of data in each of which the question sentence and the candidate question sentence are paired are similar to each other, and revises the correct answer rate associated with each of the pieces of data according to the similarity.

### (Supplementary Note 19)

A program for causing an information processing device to realize:

a question and answer unit that, in response to a question sentence input by a user, outputs a candidate question sentence corresponding to the question sentence to the user;

a detection unit that detects behavior of the user with respect to the candidate question sentence; and

an evaluation unit that evaluates the candidate question sentence with respect to the question sentence according to the behavior.

Note that the program described above can be supplied to a computer by being stored in a non-transitory computer-readable medium of any type. Non-transitory computer-readable media include tangible storage media of various types. Examples of non-transitory computer-readable media include a magnetic storage medium (for example, flexible disk, magnetic tape, hard disk drive), a magneto-optical storage medium (for example, magneto-optical disk), a CD-ROM (Read Only Memory), a CD-R, a CD-R/W, and a semiconductor memory (for example, mask ROM, PROM (Programmable ROM), EPROM (Erasable PROM), a flash ROM, and a RAM (Random Access Memory)). Note that the program may be supplied to a computer by being stored in a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

10 chatbot
11 question/answer unit
12 detection unit
13 evaluation unit
14 Q&A data storage unit
15 correct answer rate data storage unit
16 evaluation data storage unit
20 user terminal
100 information providing system
101 CPU
102 ROM
103 RAM
104 program group
105 storage device
106 drive
107 communication interface
108 input/output interface
109 bus
110 storage medium
111 communication network
121 question/answer unit
122 detection unit
123 evaluation unit

What is claimed is:

1. An information providing method comprising:
in response to a question sentence input by a user, outputting to the user a candidate question sentence corresponding to the question sentence;
detecting behavior of the user with respect to the candidate question sentence; and
evaluating the candidate question sentence with respect to the question sentence according to the behavior.

2. The information providing method according to claim 1, further comprising:
outputting the candidate question sentence onto a display screen of an information processing device operated by the user;
as the behavior, detecting an operation by the user performed on the display screen on which the candidate question sentence is shown; and
evaluating the candidate question sentence with respect to the question sentence according to the operation.

3. The information providing method according to claim 1, further comprising:
as the behavior, detecting a state of selection by the user with respect to the candidate question sentence output to the user; and
evaluating the candidate question sentence with respect to the question sentence according to the state of selection by the user with respect to the candidate question sentence.

4. The information providing method according to claim 3, further comprising:
outputting the candidate question sentence to the user, and outputting to the user an option for requesting output of another candidate question sentence;
as the behavior, detecting the state of selection by the user with respect to the candidate question sentence and the option; and
evaluating the candidate question sentence with respect to the question sentence according to the state of selection by the user with respect to the candidate question sentence and the option.

5. The information providing method according to claim 1, further comprising:
after the candidate question sentence is output to the user, detecting further input of another question sentence from the user; and
evaluating the candidate question sentence with respect to the question sentence on a basis of the question sentence and the other question sentence.

6. The information providing method according to claim 5, further comprising
analyzing a similarity relation between the question sentence and the other question sentence, and evaluating the candidate question sentence with respect to the question sentence on a basis of an analysis result.

7. The information providing method according to claim 1, further comprising:
according to the behavior of the user with respect to the candidate question sentence, outputting to the user an answer sentence corresponding to the candidate question sentence;
detecting second behavior of the user with respect to the answer sentence; and
evaluating the candidate question sentence with respect to the question sentence according to the second behavior.

8. The information providing method according to claim 1, further comprising:
as evaluation of the candidate question sentence with respect to the question sentence, calculating a correct answer rate that represents a degree that the candidate question sentence output corresponding to the question sentence is correct according to the behavior, and storing the correct answer rate in association with data in which the question sentence and the candidate question sentence are paired.

9. The information providing method according to claim 8, further comprising:
calculating similarity that represents a degree that pieces of data in each of which the question sentence and the candidate question sentence are paired are similar to each other, and revising the correct answer rate associated with each of the pieces of data according to the similarity.

10. An information providing system comprising:
at least one memory configured to store instructions; and
at least one processor configured to execute instructions to:
in response to a question sentence input by a user, output to the user a candidate question sentence corresponding to the question sentence;
detect behavior of the user with respect to the candidate question sentence; and
evaluate the candidate question sentence with respect to the question sentence according to the behavior.

11. The information providing system according to claim 10, wherein the at least one processor is configured to execute the instructions to:
output the candidate question sentence onto a display screen of an information processing device operated by the user;
as the behavior, detect an operation by the user performed on the display screen on which the candidate question sentence is shown; and
evaluate the candidate question sentence with respect to the question sentence according to the operation.

12. The information providing system according to claim 10, wherein the at least one processor is configured to execute the instructions to:
as the behavior, detect a state of selection by the user with respect to the candidate question sentence output to the user;
evaluate the candidate question sentence with respect to the question sentence according to the state of selection by the user with respect to the candidate question sentence.

13. The information providing system according to claim 12, wherein the at least one processor is configured to execute the instructions to:
output the candidate question sentence to the user, and output to the user an option for requesting output of another candidate question sentence;
as the behavior, detect the state of selection by the user with respect to the candidate question sentence and the option; and
evaluate the candidate question sentence with respect to the question sentence according to the state of selection by the user with respect to the candidate question sentence and the option.

14. The information providing system according to claim 10, wherein the at least one processor is configured to execute the instructions to:
after the candidate question sentence is output to the user, detect further input of another question sentence from the user; and
evaluate the candidate question sentence with respect to the question sentence on a basis of the question sentence and the other question sentence.

15. The information providing system according to claim 14, wherein the at least one processor is configured to execute the instructions to:
analyze a similarity relation between the question sentence and the other question sentence, and evaluate the candidate question sentence with respect to the question sentence on a basis of an analysis result.

16. The information providing system according to claim 10, wherein the at least one processor is configured to execute the instructions to:
according to the behavior of the user with respect to the candidate question sentence, output to the user an answer sentence corresponding to the candidate question sentence;
detect second behavior of the user with respect to the answer sentence; and
evaluate the candidate question sentence with respect to the question sentence according to the second behavior.

17. The information providing system according to claim 10, wherein the at least one processor is configured to execute the instructions to:
as evaluation of the candidate question sentence with respect to the question sentence, calculate a correct answer rate that represents a degree that the candidate question sentence output corresponding to the question sentence is correct according to the behavior, and store the correct answer rate in association with data in which the question sentence and the candidate question sentence are paired.

18. The information providing system according to claim 17, wherein the at least one processor is configured to execute the instructions to:
calculate similarity that represents a degree that pieces of data in each of which the question sentence and the candidate question sentence are paired are similar to each other, and revise the correct answer rate associated with each of the pieces of data according to the similarity.

19. A non-transitory computer-readable medium storing thereon a program for causing an information processing device to execute processing to:
in response to a question sentence input by a user, output a candidate question sentence corresponding to the question sentence to the user;
detect behavior of the user with respect to the candidate question sentence; and
evaluate the candidate question sentence with respect to the question sentence according to the behavior.
